(19) United States
(12) Patent Application Publication
(10) Pub. No.: US 2023/0054246 A1
(43) Pub. Date: Feb. 23, 2023

(54) ITERATIVE JOINT ESTIMATION METHOD OF VEHICLE MASS AND ROAD GRADIENT BASED ON MMRLS AND SH-STF

(71) Applicant: Beijing Institute Of Technology, Beijing (CN)

(72) Inventors: Weida Wang, Beijing (CN); Chao Yang, Beijing (CN); Jingang Liu, Changsha (CN); Wei Zhang, Beijing (CN); Zhongguo Zhang, Shandong (CN); Changle Xiang, Beijing (CN)

(21) Appl. No.: 17/293,841

(22) PCT Filed: Jul. 30, 2020
(86) PCT No.: PCT/CN2020/105989

§ 371 Date: May 13, 2021

(30) Foreign Application Priority Data
May 6, 2020 (CN) 202010370644.5

(51) Int. Cl. B60W 40/06; B60W 40/105

(52) U.S. Cl. CPC B60W 40/06; B60W 40/105; B60W 2552/15; B60W 2050/0028

(57) ABSTRACT

The present invention provides an iterative joint estimation method of vehicle mass and road gradient based on MMRLS and SH-STF, which includes the following steps: establishment of a dynamic model considering steering, MMRLS/SH-STF iterative joint estimation algorithm architecture, improved slope estimation algorithm based on SH-STF. It is an iterative joint estimation method of vehicle mass and road slope based on MMRLS and SH-STF, which is designed reasonably, and the slow-variation characteristics of vehicle mass and the time-varying characteristics of road gradient are analyzed. According to the characteristics of gradual change and time change, based on the longitudinal dynamics model of the vehicle and the steering single-track model, the system identification algorithm of multi-model fusion recursive least squares is used to calculate the vehicle mass, and the noise adaptive strong tracking based on extended Kalman filter is used.

### FIELD OF THE INVENTION

The invention relates to the technical field of quality estimation, in particular to an iterative joint estimation method of vehicle mass and road gradient based on MMRLS and SH-STF.

### BACKGROUND OF THE INVENTION

With the development of the freight industry, the number of heavy vehicles is also increasing. Compared with passenger cars, the weight range of heavy-duty vehicles is very large, it can even reach 400% from unloaded vehicles to fully-loaded vehicles. The vehicle quality is a key parameter for the automatic transmission shift control system to make gear decision, vehicle dynamics control and parameter estimation, and vehicle condition monitoring. If the parameter of vehicle quality can be used to reasonably control various parts of the vehicle, it will further improve the vehicle's power, economy and safety.

The degree of coupling between road slope and quality is relatively high. Therefore, these two parameters need to be estimated at the same time in the calculation process. Under normal circumstances, the slope of the road can be indirectly measured by the inclination sensor or acceleration sensor. However, due to the high cost of the sensor equipment, few related hardware are configured on mass-produced cars. Therefore, based on the existing sensors, the technology of soft-measuring related parameters has been widely used. At this stage, there are many researches on vehicle quality and road gradient estimation algorithms at home and abroad. In terms of quality identification, Ardalan Vahidi uses the recursive least squares method with multiple forgetting factors in the paper to identify car quality and slope in real time. Michael L McIntyre et al. first identified the car mass and the constant gradient based on the longitudinal dynamics model of the car through the least square method, and then identified the real-time changing road gradient based on the identified car quality through a nonlinear observer, so the accuracy of the estimated result is higher. Enrico Raffone combined RLS and linear Kalman filtering to estimate the vehicle mass and slope simultaneously, but they used additional acceleration sensors to collect slope information instead of estimating the slope from the dynamic formula. Lei Yulong of Jilin University proposed a vehicle quality method based on extended Kalman filtering, which simultaneously estimates the quality and slope in an algorithm. Simon Altmannshofer and others used RAWKF, RGTLS, RLS and MFRLS to estimate vehicle mass and resistance. Among them, the RAWKF algorithm has the best estimation effect. It can estimate mass, rolling resistance and air resistance more accurately, but the algorithm ignores the calculation of acceleration and slope. Liang Li et al. combined RLS and EKF. RLS was used to estimate quality, and EKF was used to estimate quality and slope at the same time. Then, the two qualities were given different confidence factors and combined to obtain the final result to improve the adaptability of the algorithm. Yahui Zhang, Dongpu Cao, etc. designed discrete observers and continuous observers for the different characteristics of the gear gap and half-shaft torque of the electric vehicle transmission system, and combined them. When the convergence is proved, the actual vehicle is used for verification, which fully demonstrates the superiority of the targeted observer algorithm for estimating multiple parameter systems. In terms of slope estimation, there are currently three main methods that can estimate the road slope in real time: GPS elevation information is used to estimate the road slope; CAN bus information and driving equations are used to estimate the road slope [11]; acceleration sensors are additionally added to estimate the road slope. Among them, the first and third methods both require additional sensors, which are difficult to meet actual application requirements. In the second method, Sebsadji et al. used the Romberg state observer to estimate the road slope, and calculated the driving force based on the tire force by establishing a tire model, which avoided the requirement for gear and other information when calculating the longitudinal force with the transmission model. Kim I et al. added the effect of vehicle pitch angle to the slope estimation algorithm, which further improved the estimation accuracy [13]. Xiaoyong Liao et al. used Adaptive Extended Kalman Filter (AEKF) to estimate the road slope, and the algorithm showed strong robustness [14, 15]. Klomp et al. used standard Kalman filtering to jointly estimate the speed of electric vehicles and the road slope. According to the characteristics of more accurate driving torque parameters of electric vehicles, the wheel slip rate is estimated, so as to correct the estimated speed and slope. In addition, the commonly used vehicle state estimation includes UKF algorithm, adaptive Kalman filter, adaptive sliding mode observer, dimensionality reduction observer, observer, closed-loop observer, and a comprehensive estimation algorithm of multiple observer data fusion. The current quality slope identification algorithms basically estimate the quality and slope at the same time, and do not consider the factor that quality is a slowly varying system parameter and slope is a time-varying state variable. If the estimation algorithm can be designed according to this characteristic, the accuracy and efficiency of the estimation model will be effectively improved.

In view of this, the present invention provides an iterative joint estimation method of vehicle mass and road gradient based on MNIRLS and SH-STF.

### SUMMARY OF THE INVENTION

In view of the shortcomings of the prior art, the purpose of the present invention is to provide an iterative joint estimation method of vehicle mass and road gradient based on MMRLS and SH-STF to solve the problems raised in the background art.

In order to achieve the above objectives, the present invention is achieved through the following technical solutions: an iterative joint estimation method of vehicle mass and road gradient based on MMRLS and SH-STF, which includes the following steps:

Step 1: Model establishment. First, in order to describe the relationship between mass and slope when the vehicle is traveling in a straight line, a vehicle longitudinal dynamics model is established. In addition, taking into account the common multi-curving road conditions of heavy vehicles, a steering dynamics monorail model is established to analyze the dynamic characteristics of the vehicle when turning, so as to derive the relationship between the vehicle steering state quantity and the quality to improve the accuracy of quality estimation, the details are as follows:

\textcircled{1}: Longitudinal dynamics model. Carry on the force analysis to the vehicle, and establish the longitudinal dynamics model of the vehicle according to Newton's second law.

Fₜ=F₃,+F_{f}+Fᵢ+Fⱼ (1)

In the formula: Fₜ—driving force, F_{w}—air resistance, F_{f}—rolling resistance, Fᵢ—ramp resistance, Fⱼ—acceleration resistance;

Among them,

$${F}_{f} = mgf cos α {F}_{t} = \frac{{T}_{tq} {i}_{g} {i}_{0} {η}_{t}}{r} {F}_{w} = \frac{1}{2} {C}_{D} A ρ {v}^{2} {F}_{i} = mg sin α {F}_{j} = δ ma$$

In the formula: T_{tg}—engine torque, i_{g}—transmission ratio, i₀—main reducer transmission ratio, ηₜ—mechanical efficiency of the drive train, r—wheel diameter, C_{D}—air resistance coefficient, A—windward area, ρ—air Density, v—vehicle speed, f—rolling resistance coefficient, δ—acceleration resistance coefficient.

Considering that the road gradient is generally small, cos α≈1, sin α≈tan α=i can be assumed.

\textcircled{2}: Steering dynamic monorail model. Considering that many road conditions require frequent steering operations of the vehicle, according to the tire friction circle theory, the generation of steering torque will affect the longitudinal driving force of the vehicle. Therefore, the steering single-track model is introduced to describe the influence of steering on the longitudinal driving force, and the accuracy of the model is improved, thereby improving the estimation accuracy. The forces F_{xV} and F_{xH}, in the wheel direction are front and rear tangential forces, and heavy vehicles are generally front-wheel drive. Therefore, it can be considered that Fₜ=F_{xV},F_{xH}=0, the forces F_{yV} and F_{yH} perpendicular to the wheel are lateral forces, and there are lateral air force F_{Ly} and air resistance F_{Lx} at the center of the wind pressure, so the force balance on the longitudinal axis of the vehicle is

$$m \frac{{v}^{2}}{ρ} sin β - m \dot{v} cos β + {F}_{x H} - {F}_{L x} - {F}_{f} + {F}_{x V} cos {δ}_{V} - {F}_{y V} sin {δ}_{V} = 0 \qquad ( 2 )$$

Assuming that the gradient of the vehicle turning is zero, simplify it to:

$$m = \frac{{F}_{t} cos {δ}_{V} - {F}_{y V} sin {δ}_{V} - {F}_{W}}{a cos β + gf - \frac{{v}^{2}}{ρ} sin β} \qquad ( 3 )$$

The reciprocal of the curvature radius p of the centroid trajectory in the centripetal acceleration

$$\frac{{v}^{2}}{ρ} ,$$

the curvature 1/ρ is the change of the heading angle (β+ψ) with the arc length u:

$$\frac{1}{ρ} = \frac{d ( β + ψ )}{du} \qquad ( 4 )$$

And because of the speed:

$$v = \frac{du}{dt} \qquad ( 5 )$$

Therefore, the centripetal acceleration:

$$\frac{{v}^{2}}{ρ} = {v}^{2} \frac{( \dot{β} + \dot{ψ} )}{v} = v ( \dot{β} + \dot{ψ} ) \qquad ( 6 )$$

Assuming that the tire side slip is linear, substitute the front axle lateral force into:

F_{yV}=c_{α}_{ᵥ}αᵥ (7)

In the formula, αᵥ is the front axle wheel slip angle, and c_{α}_{ᵥ} is the corresponding cornering stiffness;

The components of the front and rear axle speed vectors on the longitudinal axis of the vehicle must be equal, namely, the following formula is obtained:

v cos β=vᵥ cos(δᵥ−αᵥ) (8)

On the vertical axis, the following formula is obtained:

vᵥ sin(δᵥ−αᵥ)=lᵥ\dot{ψ}+v sin β (9)

From formula (8) and formula (9), the following formula is obtained:

$$tan ( {δ}_{v} - {α}_{v} ) = \frac{{l}_{v} \dot{ψ} + v sin β}{v cos β} \qquad ( 10 )$$

When the steering angle of the wheels is small, the following formula is obtained:

$${α}_{v} = - β + {δ}_{v} - {l}_{v} \frac{\dot{ψ}}{v} \qquad ( 11 )$$

When a heavy-duty vehicle is traveling at a normal high speed, the vehicle's center of mass slip angle changes very little. Therefore, \dot{β}=0 substituting formula (6), formula (7) and formula (11) into formula (3), the following formula is obtained:

$$m = \frac{{F}_{t} cos {δ}_{V} - {c}_{{α}_{v}} ( - β + {δ}_{v} - {l}_{v} \frac{\dot{ψ}}{v} ) sin {δ}_{V} - {F}_{W}}{a cos β + gf - v \dot{ψ} sin β} \qquad ( 12 )$$

Among them,

$${δ}_{v} = \frac{l}{ρ} + m \frac{{c}_{{α}_{H}} {l}_{H} - {c}_{{α}_{V}} {l}_{V}}{{c}_{{α}_{V}} {c}_{{α}_{H}} l} \frac{{v}^{2}}{ρ} \qquad ( 13 )$$

$$β = \frac{{l}_{H}}{ρ} - m \frac{{l}_{v}}{{c}_{{α}_{H}} l} \frac{{v}^{2}}{ρ} \qquad ( 14 )$$

From formula (13) and formula (14), the following formula is obtained:

$${δ}_{v} - β = \frac{{l}_{v}}{ρ} + m \frac{{l}_{H}}{{c}_{{α}_{V}} l} \frac{{v}^{2}}{ρ} > 0 \qquad ( 15 )$$

Because of \dot{β}=0, the following formula is obtained:

$$\dot{ψ} = \frac{v}{ρ} \qquad ( 16 )$$

From formula (15) and formula (16), the following formula is obtained:

$$- β + {δ}_{v} - {l}_{v} \frac{\dot{ψ}}{v} = m \frac{{l}_{H}}{{c}_{{α}_{v}} l} \frac{{v}^{2}}{ρ} > 0 \qquad ( 17 )$$

At this time, formula (12) can be simplified to:

$$m = \frac{{F}_{t} cos {δ}_{V} - {F}_{W}}{a cos β + gf - v ω ( sin β - \frac{{l}_{H}}{l} sin {δ}_{V} )} \qquad ( 18 )$$

Contrast with formula (19):

$$m = \frac{{F}_{t} - {F}_{W}}{a + gf} \qquad ( 19 )$$

It can be known that when the vehicle has a certain steering angle, the estimated value of the mass will be too large. When the steering angle is small, its influence can be ignored. The derivation of the steering model provides a theoretical basis for the mass estimation algorithm under vehicle turning conditions.

Step 2: Iterative joint estimation algorithm architecture; details are as follows:

\textcircled{1}: Quality identification algorithm based on MMRLS. Recursive least squares parameter identification means that when the identified system is running, after each new observation data is obtained, the newly introduced observation data is used to estimate the result of the previous time on the basis of the previous estimation result. According to the recursive algorithm, the new parameter estimates are obtained recursively. In this way, with the successive introduction of new observation data, the parameter calculations are performed one after another until the parameter estimates reach a satisfactory degree of accuracy.

Quality is a slowly changing system parameter. It is more reasonable to use the least square method to estimate it as a system parameter than to use the state estimation algorithm to estimate it, and it has higher calculation efficiency and estimation accuracy. Therefore, the recursive least square method is used to identify the quality.

When the vehicle is driving straight, convert equation (1) into the least square format:

Fₜ−F_{w}=(gf+gi+δa)+e (20)

Among them, Fₜ−F_{w} is the system input amount, which is recorded as F_{tw}, gf+gi+δa is the observable data amount, which is recorded as a_e, m is the system parameter to be identified, e is the system noise. Substituting it into the formula of the least square method, the least square recursive format of quality identification is as follows:

$$\hat{m} ( k + 1 ) = \hat{m} ( k ) + γ ( k + 1 ) [ {F}_{tw} ( k + 1 ) - a\_e ( k + 1 ) \hat{m} ( k ) ] \qquad ( 21 )$$

$$γ ( k + 1 ) = P ( k ) a\_e {( k + 1 ) [ a\_e ( k + 1 ) P ( k ) a\_e ( k + 1 ) + μ ( k + 1 ) ]}^{- 1}$$

$$P ( k + 1 ) = \frac{1}{μ ( k + 1 )} [ I - γ ( k + 1 ) a\_e ( k + 1 ) ] P ( k )$$

Among them, A is the forgetting factor at the k-th moment, which is selected here according to the following rule:

μ(t)=1−0.05·0.98^{t}

Similarly, when the vehicle is turning, the least square format of the quality identification algorithm is:

$${F}_{t} cos {δ}_{V} - {F}_{W} = m ( a cos β + gf - v ω ( sin β - \frac{{l}_{H}}{l} sin {δ}_{V} ) ) + e \qquad ( 22 )$$

Its recursive format is the same as formula (21);

In the actual driving process of the vehicle, it is difficult to obtain the side slip angle of the center of mass. Therefore, the side slip angle of the center of mass when turning is approximately:

$$β = arctan ( \frac{{l}_{H}}{l} tan {δ}_{v} ) \qquad ( 23 )$$

Due to the dimensionality reduction of the turning model, the accuracy of the quality identification is correspondingly reduced, but it can still play a good role in correcting. In the actual application process, in order to simplify the calculation, it is assumed that the center of gravity of the vehicle is half of the longitudinal direction of the vehicle. Therefore, the identification result will be smaller than actual. In order to improve the accuracy of quality identification, the weight values of the two models are calculated according to the residual probability distributions of the straight-driving and steering models, so as to fuse the identification results of the straight-driving and steering models.

Assuming that the estimated values of the straight driving and steering models at time k are ms(k) and mt(k), respectively, the residual value calculated by the recursive least squares at time k is

eₛ(k)=F_{tw}(k)−mₛ(k)·aₛ(k) (24)

eₜ(k)=Fₜₜ(k)−mₜ(k)·aₜ(k) (25)

Due to the positive and negative signs of the residual value, in order to more accurately quantify the influence of the RLS algorithm error, the residual calculation value is normalized by using the sigmoid function:

$${γ}_{s} ( k ) = \frac{1}{1 + {e}^{- {e}_{s} ( k )}} \qquad ( 26 )$$

$${γ}_{t} ( k ) = \frac{1}{1 + {e}^{- {e}_{t} ( k )}} \qquad ( 27 )$$

The mean square error of the output residual is:

Sₛ(k)=(I−Kₛ(k))Pₛ(k)(I−Kₛ(k))^{T} (28)

Sₜ(k)=(I−K^{t}(k))Pₜ(k)(I−Kₜ(k))^{T} (29)

Then the maximum likelihood functions corresponding to the straight driving and turning models at time k are:

$${Λ}_{s} ( k ) = \frac{1}{\sqrt{2 π \vert {S}_{s} ( k ) \vert}} {e}^{- \frac{1}{2} {γ}_{s} ( k ) {{S}_{s} ( k )}^{- 1} {{γ}_{s} ( k )}^{T}} \qquad ( 30 )$$

$${Λ}_{t} ( k ) = \frac{1}{\sqrt{2 π \vert {S}_{t} ( k ) \vert}} {e}^{- \frac{1}{2} {γ}_{t} ( k ) {{S}_{t} ( k )}^{- 1} {{γ}_{t} ( k )}^{T}} \qquad ( 31 )$$

The available output probability of each model is:

$${u}_{s} ( k ) = \frac{{Λ}_{s} ( k )}{\sum Λ ( k )} \qquad ( 32 )$$

$${u}_{t} ( k ) = \frac{{Λ}_{t} ( k )}{\sum Λ ( k )} \qquad ( 33 )$$

After obtaining the output of each model and its output probability, the fusion result can be obtained

\hat{m}(k)=mₛ(k)·uₛ(k)+mₜ(k)·uₜ(k) (34)

\textcircled{2}: The slope estimation algorithm based on EKF. Slope is a state parameter of the system. Compared with state estimation algorithms such as Kalman filter and various observers, the tracking ability of least square method is weak, and it is not suitable for estimating the time-varying state variable such as slope. Therefore, the extended Kalman filter is used to estimate the slope.

When the mathematical model of the system and measurement, the statistical characteristics of the measurement noise and the initial value of the system state are known, Kalman filter uses the measurement data of the input signal and the system model equation to obtain the optimal estimation value of the system state variables and the input signal in real time. Classical Kalman filtering treats the signal process as the output of a linear system under the action of white noise, and describes this input-output relationship with a state equation, and its algorithm uses a recursive form. Its mathematical structure is simple, the amount of calculation is small, and it is suitable for real-time calculation. However, the classical Kalman filter is only applicable to the state estimation of linear systems. For nonlinear systems, there is Extended Kalman Filter (EKF). EKF simplifies the nonlinear model to a linear model by performing Taylor expansion of the nonlinear function near the best estimation point, discarding high-order components, and then using the classic Kalman technique to complete the estimation. EKF is widely used in the state estimation of nonlinear systems.

Write formula (1) as follows:

Fⱼ=Fₜ−F_{w}−F_{f}−Fᵢ (35)

Substituting various formulas, formula (35) becomes as follows:

$$\dot{v} = \frac{1}{δ} ( \frac{{T}_{tq} {i}_{g} {i}_{0} {η}_{t}}{mr} - \frac{1}{2 m} {C}_{D} A {ρ v}^{2} - gf - gi ) \qquad ( 36 )$$

The state space model of the system is established. The vehicle speed v and the road gradient i are selected as state variables. Since the road gradient i changes slowly, it can be considered that its derivative with respect to time is zero. Therefore, there are the following differential equations:

$$\{ \begin{matrix}\dot{v} ( t ) = \frac{1}{δ} ( \frac{{T}_{tq} ( t ) {i}_{g} {i}_{0} {η}_{t}}{m ( t ) r} - \frac{1}{2 m ( t )} {C}_{D} A {ρ v ( t )}^{2} - gf - gi ( t ) ) \\ \dot{i} ( t ) = 0\end{matrix} \qquad ( 37 )$$

Forward Euler method is used to discretize the state space equation to obtain the discretized difference equation

$$\{ \begin{matrix}{v}_{k + 1} = {v}_{k} + \frac{Δ t}{δ} ( \frac{{T}_{tq} ( {t}_{k} ) {i}_{g} {i}_{0} {η}_{T}}{{m}_{k} r} - \frac{1}{2 {m}_{k}} {C}_{D} A {ρ v}_{k}^{2} - gf - {gi}_{k} ) \\ {i}_{k + 1} = {i}_{k}\end{matrix} \qquad ( 38 )$$

Assuming that the system noise vector and the measurement noise vector are Wₖ and Vₖ respectively, they are independent Gaussian white noise with a mean value of zero. The system noise covariance matrix is Qₖ, and the measurement noise covariance matrix is Rₖ, then the system state equation can be deduced as:

$$[ \begin{matrix}{v}_{k + 1} \\ {i}_{k + 1}\end{matrix} ] = [ \begin{matrix}{v}_{k} + Δ t ( \dot{v} ( {t}_{k} ) ) \\ {i}_{k}\end{matrix} ] + {W}_{k} \qquad ( 39 )$$

Among them,

$$\dot{v} ( {t}_{k} ) = \frac{1}{δ} ( \frac{{T}_{tq} ( {t}_{k} ) {i}_{g} {i}_{0} {η}_{T}}{{m}_{k} r} - \frac{1}{2 {m}_{k}} {C}_{D} A {ρ v}_{k}^{2} - gf - {gi}_{k} ) \qquad ( 40 )$$

The system measurement equation is:

$${z}_{k} = [ \begin{matrix}1 & 0\end{matrix} ] [ \begin{matrix}{v}_{k} \\ {i}_{k}\end{matrix} ] + {V}_{k} \qquad ( 41 )$$

Equations (39) and (41) constitute the state space expression of the system, the expression is as follows:

$$\{ \begin{matrix}{x}_{k + 1} = f ( {x}_{k} ) + {W}_{k} \\ {z}_{k} = H {x}_{k} + {V}_{k}\end{matrix} \qquad ( 42 )$$

In the formula, H is the measurement matrix;

From equation (42), the slope is estimated according to the EKF algorithm, and the process equation vector function is expanded to obtain the Jacobian matrix:

$${F}_{k} = [ \begin{matrix}\frac{\partial {f}_{1}}{\partial v} & \frac{\partial {f}_{1}}{\partial i} \\ \frac{\partial {f}_{2}}{\partial v} & \frac{\partial {f}_{2}}{\partial i}\end{matrix} ] = [ \begin{matrix}1 - \frac{{C}_{D} A ρ v}{δ m} Δ t & - \frac{g Δ t}{δ} \\ 0 & 1\end{matrix} ] \qquad ( 43 )$$

The EKF time update equation is:

x̅_{k+1/k}=f(x̅ₖ)

P_{k+1/k}=Fₖ(\hat{x}ₖ)PₖFₖ^{T}(\hat{x}ₖ)+Qₖ (44)

In the formula: \hat{x}ₖ—the optimal estimated value of the state variable at the previous moment, Pₖ—the error at the previous moment, \hat{x}_{k+1/k}—the prior estimated value of the state variable, P_{k+1/k}—the prior error covariance, Fₖ—the Jacobian of the process vector function f matrix.

The measurement update equation is:

Kₖ₊₁P_{k+1/k}H^{T}(HP_{k+1/k}H^{T}+Rₖ₊₁)⁻¹

\hat{x}ₖ₊₁=\hat{x}_{k+1/k}Kₖ₊₁(zₖ₊₁−H\hat{x}_{k+1/k})

Pₖ₊₁(I−Kₖ₊₁H)P_{k+1/k} (45)

In the formula: Kₖ₊₁—Kalman gain, \hat{x}ₖ₊₁—posterior estimated value of state variables, Pₖ₊₁ —posterior error covariance, I—identity matrix;

According to the measured noise covariance Rₖ and the prior error covariance P_{k+1/k}, the Kalman gain dynamically adjusts the weight of the measured variable zₖ and its estimated H\hat{x}_{k+1/k};

Step 3: Improved slope estimation algorithm based on SH-STF. In the actual operation process, changes in the environment may cause changes in the system model or sudden changes in noise. For systems that are prone to changes in the filtering process, if the traditional Kalman filtering is used, it is easy to cause the deviation of the optimal estimation value to increase, or even to diverge the filtering. In the process of vehicle driving, in order to reduce the deterioration of the estimation result caused by the change of the system environment and accelerate the filtering convergence process, the Sage-Husa adaptive filtering algorithm is used to modify the traditional extended Kalman filtering. The Sage-Husa adaptive filtering algorithm is based on the Kalman filter and based on the principle of maximum posterior. It uses the data of the measured variables to dynamically estimate the statistical characteristics of the noise in real time, so as to realize the self-adaptation of the estimation algorithm noise. The Husa algorithm process is as follows.

The time update is shown in the formula. Before proceeding to the next measurement update, add the calculation formula for the measurement noise:

eₖ₊₁=zₖ₊₁−_{k+1/k}

\hat{R}ₖ₊₁=(1−dₖ)\hat{R}ₖ+dₖ(eₖ₊₁^{T}eₖ₊₁−HP_{k+1/k}H^{T}) (46)

Among them, dk is the weight of recent data, usually defined as follows

$${d}_{k} = \frac{1 - b}{1 - {b}^{k + 1}} \qquad ( 47 )$$

Among them, b is the forgetting factor, which indicates the degree of forgetting of historical data, which can limit the memory length of the filter and enhance the effect of the newly observed data on the current estimation. The general value is 0.95-0.99.

After the measurement noise is calculated, the Kalman filter measurement update is performed according to the noise value into the formula, and then the system noise at the next moment is calculated:

\hat{Q}ₖ₊₁=(1−dₖ)\hat{Q}ₖ+dₖ(Kₖ₊₁eₖ₊₁eₖ₊₁^{T}Kₖ₊₁^{T}+Pₖ₊₁−F_{k+1/k}PₖF_{k+1/k}^{T}) (48)

When k gradually increases, dₖ will tend to 1-b, that is, due to b∈[0.95, 0.99]

$${lim}_{k \to ∞} {d}_{k} ∈ [ 0.01 , 0.05 ] ,$$

when the filtering starts, the dₖ value decreases rapidly, which means that the weight of the observation value at the current moment on the noise estimate is weakened, and the noise information is estimated Most of it still depends on historical information. Therefore, when there is a sudden change in the system, the estimated value of the noise by the Sage-Husa algorithm will not reflect the real situation of the system, and it will easily lead to filter divergence.

In order to solve the possible filtering divergence of the Sage-Husa algorithm in the case of sudden slope changes, the Strong Tracking Filtering Theory (STF) is introduced to improve the tracking and estimation ability of the sudden change system.

A time-varying fading factor is introduced to modify the state prediction error covariance matrix and the corresponding Kalman gain matrix in the Kalman filter recursive process, thereby forcing the residual sequence to be orthogonal or approximately orthogonal. When there is uncertainty or sudden change in the model or measurement value, the STF algorithm calculates the fading factor in order to ensure the irrelevance of the innovation sequence, thereby reducing the influence of historical data on the current filter calculation value, so that the algorithm has the ability to track the sudden change state.

For the Kalman filter recursive system, the steps of state estimation are as follows:

\hat{x}ₖ=\hat{x}_{k/k-1}+Kₖ(yₖ−ŷₖ)

=\hat{x}ₖ+Kₖγₖ (49)

Among them, A is the residual sequence obtained by the state estimation filter equation. The strong tracking filter adds an equation under the condition that the Kalman filter theory satisfies the equation, so that the residual sequence at different times is orthogonal at all times:

E[(xₖ−\hat{x}_{k/k-1})(xₖ−\hat{x}_{k/k-1})_{T}]=min (50)

E[yₖ^{T}yₖ₊ⱼ]=0,k=1,2, . . . ;j=1,2, (51)

In order to make the formula hold, the STF algorithm introduces a time-varying fading factor to adjust the prediction error covariance matrix in real time to further update the Kalman gain. The calculation method of the fading factor is as follows:

$${λ}_{k} = \{ \begin{matrix}{c}_{k} & {c}_{k} > 1 \\ 1 & {c}_{k} \leq 1\end{matrix} \qquad ( 52 )$$

$${c}_{k} = \frac{t r ( {N}_{k + 1} )}{t r ( {M}_{k + 1} )} \qquad ( 53 )$$

$${N}_{k + 1} = {V}_{k + 1} - {H}_{k} {Q}_{k} {H}_{k}^{T} - β {R}_{k - 1} \qquad ( 54 )$$

$${M}_{k + 1} = {H}_{k} {F}_{k} {P}_{k} {F}_{k}^{T} {H}_{k}^{T} \qquad ( 55 )$$

Among them, Vₖ is the residual covariance matrix, defined as follows:

$${V}_{k} = E [ {γ}_{k}^{T} {γ}_{k + j} ] = \{ \begin{matrix}{γ}_{1} {γ}_{1}^{T} & k = 0 \\ \frac{ρ {V}_{k} + {γ}_{k + 1}^{T}}{1 + ρ} & k \geq 1\end{matrix} \qquad ( 56 )$$

Among them, 0<ρ≤1 is the forgetting factor, which is generally taken as 0.95, and β≥1 is the weakening factor, increasing the value of β can make the estimation result smoother. F and H are the Jacobian matrices of the system state equation and the observation equation, respectively.

Compared with the original Kalman filter, the strong tracking filter has a very strong ability to track abrupt states. It can maintain the ability to track the state when the system undergoes a sudden change from the equilibrium state.

In summary, the Sage-Husa algorithm can estimate the statistical characteristics of noise without prior information, but it is easy to destroy the positive definiteness of the noise variance matrix and cause filtering divergence. STF can enhance the stability of the filtering system. However, due to the direct correction of the Kalman gain in the filtering process, the optimal estimation result has certain fluctuations. Therefore, the characteristics of the two can be combined. On the one hand, the Sage-Husa algorithm is used to estimate the noise in the filtering process; on the other hand, the STF algorithm is used to correct the covariance in real time in the recursive process.

Step 4: Iterative joint estimation algorithm is used to calculate vehicle mass and road gradient. Since both the Sage-Husa algorithm and STF are based on innovation calculations and affect the covariance in the iterative process, the two algorithms cannot be applied at the same time. For the estimation system, the Sage-Husa algorithm has higher requirements on the stability of the system. When the system noise is known, it can estimate the statistical characteristics of the measurement noise with good accuracy. When a sudden change occurs in the system state, the Sage-Husa algorithm will consider that the increase in measurement noise causes an increase in innovation, and the proportion of measurement information that is originally increased will decrease instead. At this time, if the STF algorithm is used for correction, the optimal estimation result of the STF algorithm will be based on the observation value, that is, it is believed that the accuracy of the observation result is much greater than the state prediction value.

As a preferred embodiment of the present invention, in the longitudinal dynamics model of step 1, each constant takes the following values: ηₜ=0.95, C_{D}=0.3, ρ/N·s²·m⁻⁴=1.2258, f=0.0041+0.0000256v δ=1.1.

As a preferred embodiment of the present invention, in the first step, the vehicle speed and nominal engine torque values can be obtained from the vehicle-mounted CAN bus information.

As a preferred embodiment of the present invention, in the fourth step, in the slope estimation algorithm, when the vehicle is running smoothly, the Sage-Husa algorithm is used to perform adaptive noise estimation, so as to reduce the state estimation error of the system and improve the observation accuracy of the filter. When the vehicle driving state changes suddenly, the STF algorithm is used to improve the tracking estimation ability of the Kalman filter and enhance the robustness of the estimation algorithm. Therefore, the Sage-Husa algorithm can be used in combination with the STF algorithm. In a filter cycle, combined with the Kusovkov HT filter convergence criterion, when the filter converges, the Sage-Husa algorithm is used to estimate the slope, when the filter diverges; the STF algorithm is used to estimate the slope.

The beneficial effects of the present invention:

1. The iterative joint estimation method of vehicle mass and road slope based on MMRLS and SH-STF analyzes the slowly varying characteristics of vehicle mass and the time-varying characteristics of road gradient. According to the slowly changing and time-varying characteristics, based on the vehicle longitudinal dynamics model and the steering monorail model, the system identification algorithm of recursive least squares is used to calculate the vehicle mass, and the Kalman filter state estimate is used to calculate the road slope by the calculation method, so that the algorithm is better adapted to the estimated variables.

2. This iterative joint estimation method of vehicle mass and road gradient based on MMRLS and SH-STF proposes a new iterative joint estimation algorithm based on MMRLS and SH-STF. Multi-model fusion is used to deal with vehicle mass estimation under steering conditions and straight-through conditions. Aiming at the problem of filter divergence caused by sudden gradient, a strong tracking filter algorithm based on noise adaptation is proposed. Noise adaptive estimation is used when driving is stable, and strong tracking filtering is used when driving state changes suddenly, which improves the accuracy and stability of slope estimation.

3. This iterative joint estimation method of vehicle quality and road gradient based on MMRLS and SH-STF combines with CarSim software, the joint estimation method is simulated and verified on the Simulink platform with variable quality gradients under multiple working conditions. The influence of rolling resistance, air resistance and transmission efficiency accuracy on the estimation results is analyzed. The results show that under different road conditions, the joint model can accurately estimate the vehicle mass and track changes in road slope in real time. Rolling resistance and air resistance have little effect on the estimation results, while the value of transmission efficiency has a greater impact on the estimation results.

4. This iterative joint estimation method of vehicle quality and road gradient based on MMRLS and SH-STF collects real-vehicle driving data under comprehensive road sections, and verifies the algorithm in real-vehicle experiments. The results show that the joint estimation method can accurately estimate the vehicle mass and slope in real time, and the joint estimation method is based on the recursive least squares and the second-order matrix extended Kalman filter algorithm for improved design, simple structure, small amount of calculation, and it has high real-car application value.

### BRIEF DESCRIPTION OF THE FIGURES

FIG. 1 is a schematic flow chart of an iterative joint estimation method of vehicle mass and road slope based on MMRLS and SH-STF;

FIG. 2 is a longitudinal force analysis diagram of a vehicle on a slope based on the iterative joint estimation method of vehicle mass and road slope based on MMRLS and SH-STF of the present invention;

FIG. 3 is a schematic diagram of the force situation of the monorail model of the iterative joint estimation method of vehicle mass and road slope based on MMRLS and SH-STF of the present invention;

FIG. 4 is a schematic diagram of the kinematics parameters of the monorail model of the iterative joint estimation method of vehicle mass and road slope based on MMRLS and SH-STF of the present invention;

FIG. 5 is a schematic diagram of the algorithm architecture of the iterative joint estimation method of vehicle mass and road slope based on MMRLS and SH-STF of the present invention.

### DESCRIPTION OF THE INVENTION

In order to make it easy to understand the technical means, creative features, objectives and effects achieved by the present invention, the present invention will be further explained below in conjunction with specific implementations.

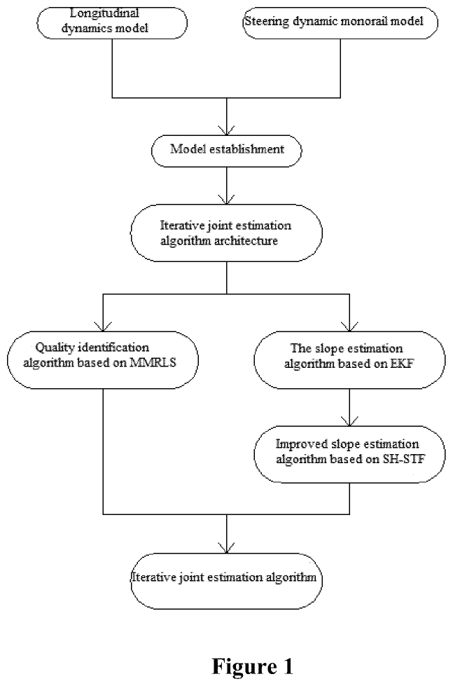

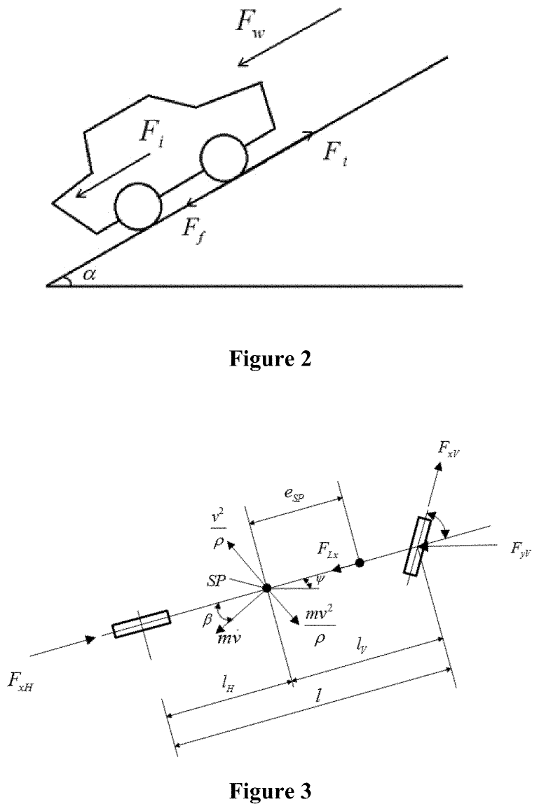

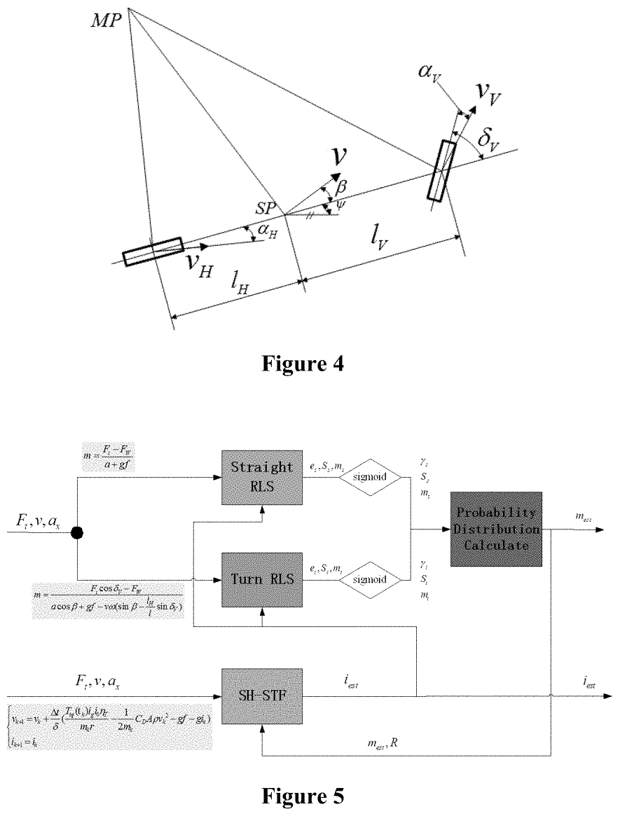

Please refer to FIGS. 1 to 5, the present invention provides a technical solution: an iterative joint estimation method of vehicle mass and road gradient based on MMRLS and SH-STF, which includes the following steps:

Step 1: Model establishment. First, in order to describe the relationship between mass and slope when the vehicle is traveling in a straight line, a longitudinal dynamics model of the vehicle is established. In addition, considering the common multi-curving road conditions of heavy vehicles, a steering dynamics monorail model is established to analyze the dynamic characteristics of the vehicle when turning, so as to derive the relationship between the vehicle steering state quantity and the mass, and improve the quality estimation accuracy. The details are as follows:

\textcircled{1}: Longitudinal dynamics model. Carry on the force analysis to the vehicle, and establish the longitudinal dynamics model of the vehicle according to Newton's second law.

Fₜ=F_{w}+F_{f}+Fᵢ+Fⱼ (57)

In the formula: Fₜ—driving force, F_{w}—air resistance, F_{f}—rolling resistance, Fᵢ—ramp resistance, Fⱼ—acceleration resistance;

Among them,

$${F}_{f} = mgf cos α {F}_{t} = \frac{{T}_{tq} {i}_{g} {i}_{0} {η}_{t}}{r} {F}_{w} = \frac{1}{2} {C}_{D} A ρ {v}^{2} {F}_{i} = mg sin α {F}_{j} = δ ma$$

In the formula: T_{tq}—engine torque, i_{g}—transmission ratio, i₀—main reducer transmission ratio, ηₜ—mechanical efficiency of the drive train, r—wheel diameter, C_{D}—air resistance coefficient, A—windward area, ρ—air Density, v—vehicle speed, f—rolling resistance coefficient, δ—acceleration resistance coefficient.

Considering that the road gradient is generally small, cos α≈1, sin α≈tan α=i can be assumed;

\textcircled{2}: Steering dynamic monorail model. Considering that many road conditions require frequent steering operations of the vehicle, according to the tire friction circle theory, the generation of steering torque will affect the longitudinal driving force of the vehicle. Therefore, the steering single-track model is introduced to describe the influence of steering on the longitudinal driving force, and the accuracy of the model is improved, thereby improving the estimation accuracy. The forces F_{xV} and F_{xH} in the wheel direction are front and rear tangential forces, and heavy vehicles are generally front-wheel drive. Therefore, it can be considered that Fₜ=F_{xV},F_{xH}=0, the forces F_{yV} and F_{yH} perpendicular to the wheel are lateral forces, and there are lateral air force F_{Ly} and air resistance F_{Lx} at the center of the wind pressure, so the force balance on the longitudinal axis of the vehicle is

$$m \frac{{v}^{2}}{ρ} sin β - m \dot{v} cos β + {F}_{x H} - {F}_{L x} - {F}_{f} + {F}_{x V} cos {δ}_{V} - {F}_{y V} sin {δ}_{V} = 0 \qquad ( 58 )$$

Assuming that the gradient of the vehicle turning is zero, simplify it to:

$$m = \frac{{F}_{t} cos {δ}_{V} - {F}_{y V} sin {δ}_{V} - {F}_{W}}{a cos β + gf - \frac{{v}^{2}}{ρ} - sin β} \qquad ( 59 )$$

The reciprocal of the curvature radius p of the centroid trajectory in the centripetal acceleration

$$\frac{{v}^{2}}{ρ}$$

the curvature 1/ρ is the change of the heading angle (β+ψ) with the arc length u:

$$\frac{1}{ρ} = \frac{d ( β + ψ )}{d u} \qquad ( 60 )$$

And because of the speed:

$$v = \frac{du}{dt} \qquad ( 61 )$$

Therefore, the centripetal acceleration:

$$\frac{{v}^{2}}{ρ} = {v}^{2} \frac{( \dot{β} + \dot{ψ} )}{v} = v ( \dot{β} + \dot{ψ} ) \qquad ( 62 )$$

Assuming that the tire side slip is linear, substitute the front axle lateral force into:

F_{yV}=c_{α}_{_{V}}α_{V} (63)

In the formula, α_{V} is the front axle wheel slip angle, and c_{α}_{_{V}} is the corresponding cornering stiffness;

The components of the front and rear axle speed vectors on the longitudinal axis of the vehicle must be equal, namely, the following formula is obtained:

v cos β=vᵥ cos(βᵥ−αᵥ) (64)

On the vertical axis, the following formula is obtained:

vᵥ sin(δᵥ−αᵥ)=lᵥ\dot{ψ}+v sin β (65)

From formula (8) and formula (9), the following formula is obtained:

$$tan ( {δ}_{v} - {α}_{v} ) = \frac{{l}_{v} \dot{ψ} + v sin β}{v cos β} \qquad ( 66 )$$

When the steering angle of the wheels is small, the following formula is obtained:

$${α}_{v} = - β + {δ}_{v} - {l}_{v} \frac{\dot{ψ}}{v} \qquad ( 67 )$$

When a heavy-duty vehicle is traveling at a normal high speed, the vehicle's center of mass slip angle changes very little. Therefore, \dot{β}=0 substituting formula (6), formula (7) and formula (11) into formula (3), the following formula is obtained:

$$m = \frac{{F}_{t} cos {δ}_{V} - {c}_{{α}_{v}} ( - β + {δ}_{v} - {l}_{v} \frac{\dot{ψ}}{v} ) sin {δ}_{V} - {F}_{W}}{a cos β + gf - v \dot{ψ} sin β} \qquad ( 68 )$$

Among them,

$${δ}_{v} = \frac{l}{ρ} + m \frac{{c}_{{α}_{H}} {l}_{H} - {c}_{{α}_{V}} {l}_{V}}{{c}_{{α}_{V}} {c}_{{α}_{H}} l} \frac{{v}^{2}}{ρ} \qquad ( 69 )$$

$$β = \frac{{l}_{H}}{ρ} - m \frac{{l}_{v}}{{c}_{{α}_{H}} l} \frac{{v}^{2}}{ρ} \qquad ( 70 )$$

From formula (13) and formula (14), the following formula is obtained:

$${δ}_{v} - β = \frac{{l}_{v}}{ρ} + m \frac{{l}_{H}}{{c}_{{α}_{V}} l} \frac{{v}^{2}}{ρ} > 0 \qquad ( 71 )$$

Because of \dot{β}=0, the following formula is obtained:

$$\dot{ψ} = \frac{v}{ρ} \qquad ( 72 )$$

From formula (15) and formula (16), the following formula is obtained:

$$- β + {δ}_{v} - {l}_{v} \frac{\dot{ψ}}{v} = m \frac{{l}_{H}}{{c}_{{α}_{V}} l} \frac{{v}^{2}}{ρ} > 0 \qquad ( 73 )$$

At this time, formula (12) can be simplified to:

$$m = \frac{{F}_{t} cos {δ}_{V} - {F}_{W}}{a cos β + gf - v ω ( sin β - \frac{{l}_{H}}{l} sin {δ}_{V} )} \qquad ( 74 )$$

Contrast with formula (19):

$$m = \frac{{F}_{t} - {F}_{W}}{a + gf} \qquad ( 75 )$$

It can be known that when the vehicle has a certain steering angle, the estimated value of the mass will be too large. When the steering angle is small, its influence can be ignored. The derivation of the steering model provides a theoretical basis for the mass estimation algorithm under vehicle turning conditions.

Step 2: Iterative joint estimation algorithm architecture; details are as follows:

\textcircled{1}: Quality identification algorithm based on MMRLS. Recursive least squares parameter identification means that when the identified system is running, after each new observation data is obtained, the newly introduced observation data is used to estimate the result of the previous time on the basis of the previous estimation result. According to the recursive algorithm, the new parameter estimates are obtained recursively. In this way, with the successive introduction of new observation data, the parameter calculations are performed one after another until the parameter estimates reach a satisfactory degree of accuracy.

Quality is a slowly changing system parameter. It is more reasonable to use the least square method to estimate it as a system parameter than to use the state estimation algorithm to estimate it, and it has higher calculation efficiency and estimation accuracy. Therefore, the recursive least square method is used to identify the quality.

When the vehicle is driving straight, convert equation (1) into the least square format:

Fₜ−F_{w}=m(gf+gi+βa)+e (76)

Among them, Fₜ−F_{w} is the system input amount, which is recorded as F_{tw}, gf+gi+δa is the observable data amount, which is recorded as a_e, m is the system parameter to be identified, e is the system noise. Substituting it into the formula of the least square method, the least square recursive format of quality identification is as follows:

$$\hat{m} ( k + 1 ) = \hat{m} ( k ) + γ ( k + 1 ) [ {F}_{tw} ( k + 1 ) - a\_e ( k + 1 ) \hat{m} ( k ) ] \qquad ( 77 )$$

$$γ ( k + 1 ) = P ( k ) a\_e {( k + 1 ) [ a\_e ( k + 1 ) P ( k ) a\_e ( k + 1 ) + μ ( k + 1 ) ]}^{- 1}$$

$$P ( k + 1 ) = \frac{1}{μ ( k + 1 )} [ I - γ ( k + 1 ) a\_e ( k + 1 ) ] P ( k )$$

Among them, A is the forgetting factor at the k-th moment, which is selected here according to the following rule:

μ(t)=1−0.05·0.98^{t}

Similarly, when the vehicle is turning, the least square format of the quality identification algorithm is:

$${F}_{t} cos {δ}_{V} - {F}_{W} = m ( a cos β + gf - v ω ( sin β - \frac{{l}_{H}}{l} sin {δ}_{V} ) ) + e \qquad ( 78 )$$

Its recursive format is the same as formula (21);

In the actual driving process of the vehicle, it is difficult to obtain the side slip angle of the center of mass. Therefore, the side slip angle of the center of mass when turning is approximately:

$$β = arctan ( \frac{{l}_{H}}{l} tan {δ}_{v} ) \qquad ( 79 )$$

Due to the dimensionality reduction of the turning model, the accuracy of the quality identification is correspondingly reduced, but it can still play a good role in correcting. In the actual application process, in order to simplify the calculation, it is assumed that the center of gravity of the vehicle is half of the longitudinal direction of the vehicle. Therefore, the identification result will be smaller than actual. In order to improve the accuracy of quality identification, the weight values of the two models are calculated according to the residual probability distributions of the straight-driving and steering models, so as to fuse the identification results of the straight-driving and steering models.

Assuming that the estimated values of the straight driving and steering models at time k are ms(k) and mt(k), respectively, the residual value calculated by the recursive least squares at time k is

eₛ(k)=F_{tw}(k)−mₛ(k)·aₛ(k) (80)

eₜ(k)=Fₜₜ(k)−mₜ(k)·aₜ(k) (81)

Due to the positive and negative signs of the residual value, in order to more accurately quantify the influence of the RLS algorithm error, the residual calculation value is normalized by using the sigmoid function:

$${γ}_{s} ( k ) = \frac{1}{1 + {e}^{- {e}_{s} ( k )}} \qquad ( 82 )$$

$${γ}_{t} ( k ) = \frac{1}{1 + {e}^{- {e}_{t} ( k )}} \qquad ( 83 )$$

The mean square error of the output residual is:

Sₛ(k)=(I−Kₛ(k))Pₛ(k)(I−Kₛ(k))^{T} (84)

Sₜ(k)=(I−Kₜ(k))Pₜ(k)(I−Kₜ(k))^{T} (85)

Then the maximum likelihood functions corresponding to the straight driving and turning models at time k are:

$${Λ}_{s} ( k ) = \frac{1}{\sqrt{2 π \vert {S}_{s} ( k ) \vert}} {e}^{- \frac{1}{2} {γ}_{s} ( k ) {{S}_{s} ( k )}^{- 1} {{γ}_{s} ( k )}^{T}} \qquad ( 86 )$$

$${Λ}_{t} ( k ) = \frac{1}{\sqrt{2 π \vert {S}_{t} ( k ) \vert}} {e}^{- \frac{1}{2} {γ}_{t} ( k ) {{S}_{t} ( k )}^{- 1} {{γ}_{t} ( k )}^{T}} \qquad ( 87 )$$

The available output probability of each model is:

$${u}_{s} ( k ) = \frac{{Λ}_{s} ( k )}{\sum Λ ( k )} \qquad ( 88 )$$

$${u}_{t} ( k ) = \frac{{Λ}_{t} ( k )}{\sum Λ ( k )} \qquad ( 89 )$$

After obtaining the output of each model and its output probability, the fusion result can be obtained

\hat{m}(k)=mₛ(k)·uₛ(k)+mₜ(k)·uₜ(k) (90)

\textcircled{2}: The slope estimation algorithm based on EKF. Slope is a state parameter of the system. Compared with state estimation algorithms such as Kalman filter and various observers, the tracking ability of least square method is weak, and it is not suitable for estimating the time-varying state variable such as slope. Therefore, the extended Kalman filter is used to estimate the slope.

When the mathematical model of the system and measurement, the statistical characteristics of the measurement noise and the initial value of the system state are known, Kalman filter uses the measurement data of the input signal and the system model equation to obtain the optimal estimation value of the system state variables and the input signal in real time. Classical Kalman filtering treats the signal process as the output of a linear system under the action of white noise, and describes this input-output relationship with a state equation, and its algorithm uses a recursive form. Its mathematical structure is simple, the amount of calculation is small, and it is suitable for real-time calculation. However, the classical Kalman filter is only applicable to the state estimation of linear systems. For nonlinear systems, there is Extended Kalman Filter (EKF). EKF simplifies the nonlinear model to a linear model by performing Taylor expansion of the nonlinear function near the best estimation point, discarding high-order components, and then using the classic Kalman technique to complete the estimation. EKF is widely used in the state estimation of nonlinear systems.

Write formula (1) as follows:

Fⱼ=Fₜ−F_{w}−F_{f}−Fᵢ (91)

Substituting various formulas, formula (35) becomes as follows:

$$\dot{v} = \frac{1}{δ} ( \frac{{T}_{tq} {i}_{g} {i}_{0} {η}_{t}}{m r} - \frac{1}{2 m} {C}_{D} A ρ {v}^{2} - gf - gi ) \qquad ( 92 )$$

The state space model of the system is established. The vehicle speed v and the road gradient i are selected as state variables. Since the road gradient i changes slowly, it can be considered that its derivative with respect to time is zero. Therefore, there are the following differential equations:

$$\{ \begin{matrix}\dot{v} ( t ) = \frac{1}{δ} ( \frac{{T}_{t q} ( t ) {i}_{g} {i}_{0} {η}_{t}}{m ( t ) r} - \frac{1}{2 m ( t )} {C}_{D} A ρ {v ( t )}^{2} - gf - gi ( t ) ) \\ \dot{i} ( t ) = 0\end{matrix} \qquad ( 93 )$$

Forward Euler method is used to discretize the state space equation to obtain the discretized difference equation

$$\{ \begin{matrix}{v}_{k + 1} = {v}_{k} + \frac{Δ t}{δ} ( \frac{{T}_{t q} ( {t}_{k} ) {i}_{g} {i}_{0} {η}_{T}}{{m}_{k} r} - \frac{1}{2 {m}_{k}} {C}_{D} A ρ {v}_{k}^{2} - gf - {gi}_{k} ) \\ {i}_{k + 1} = {i}_{k}\end{matrix} \qquad ( 94 )$$

Assuming that the system noise vector and the measurement noise vector are Wₖ and Vₖ respectively, they are independent Gaussian white noise with a mean value of zero. The system noise covariance matrix is Qₖ, and the measurement noise covariance matrix is Rₖ, then the system state equation can be deduced as:

$$[ \begin{matrix}{v}_{k + 1} \\ {i}_{k + 1}\end{matrix} ] = [ \begin{matrix}{v}_{k} + Δ t ( \dot{v} ( {t}_{k} ) ) \\ {i}_{k}\end{matrix} ] + {W}_{k} \qquad ( 95 )$$

Among them,

$$\dot{v} ( {t}_{k} ) = \frac{1}{δ} ( \frac{{T}_{t q} ( {t}_{k} ) {i}_{g} {i}_{0} {η}_{T}}{{m}_{k} r} - \frac{1}{2 {m}_{k}} {C}_{D} A ρ {v}_{k}^{2} - gf - {gi}_{k} ) \qquad ( 96 )$$

The system measurement equation is:

$${z}_{k} = [ \begin{matrix}1 & 0\end{matrix} ] [ \begin{matrix}{v}_{k} \\ {i}_{k}\end{matrix} ] + {V}_{k} \qquad ( 97 )$$

Equations (39) and (41) constitute the state space expression of the system, the expression is as follows:

$$\{ \begin{matrix}{x}_{k + 1} = f ( {x}_{k} ) + {W}_{k} \\ {z}_{k} = H {x}_{k} + {V}_{k}\end{matrix} \qquad ( 98 )$$

In the formula, H is the measurement matrix;

From equation (42), the slope is estimated according to the EKF algorithm, and the process equation vector function is expanded to obtain the Jacobian matrix:

$${F}_{k} = [ \begin{matrix}\frac{\partial {f}_{1}}{\partial v} & \frac{\partial {f}_{1}}{\partial i} \\ \frac{\partial {f}_{2}}{\partial v} & \frac{\partial {f}_{2}}{\partial i}\end{matrix} ] = [ \begin{matrix}1 - \frac{{C}_{D} A ρ v}{δ m} & - \frac{g Δ t}{δ} \\ 0 & 1\end{matrix} ] \qquad ( 99 )$$

The EKF time update equation is:

\hat{x}_{k+1/k}=f(\hat{x}ₖ)

P_{k+1/k}Fₖ(\hat{x}ₖ)PₖFₖ^{T}(\hat{x}ₖ)+Qₖ (100)

In the formula: \hat{x}ₖ—the optimal estimated value of the state variable at the previous moment, Pₖ—the error at the previous moment, \hat{x}_{k-1/k}—the prior estimated value of the state variable, P_{k+1/k}—the prior error covariance, Fₖ—the Jacobian of the process vector function f matrix.

The measurement update equation is

Kₖ₊₁P_{k+1/k}H^{T}(HP_{k+1/k}H^{T}+Rₖ₊₁)⁻¹

\hat{x}ₖ₊₁=\hat{x}_{k+1/k}+Kₖ₊₁(zₖ₊₁−H\hat{x}_{k+1/k})

Pₖ₊₁=(I−Kₖ₊₁H)P_{k+1/k} (101)

In the formula: A—Kalman gain, B—posterior estimated value of state variables, C— posterior error covariance, D—identity matrix;

According to the measured noise covariance Rₖ and the prior error covariance P_{k+1/k}, the Kalman gain dynamically adjusts the weight of the measured variable zₖ and its estimated H\hat{x}_{k+1/k};

Step 3: Improved slope estimation algorithm based on SH-STF. In the actual operation process, changes in the environment may cause changes in the system model or sudden changes in noise. For systems that are prone to changes in the filtering process, if the traditional Kalman filtering is used, it is easy to cause the deviation of the optimal estimation value to increase, or even to diverge the filtering. In the process of vehicle driving, in order to reduce the deterioration of the estimation result caused by the change of the system environment and accelerate the filtering convergence process, the Sage-Husa adaptive filtering algorithm is used to modify the traditional extended Kalman filtering. The Sage-Husa adaptive filtering algorithm is based on the Kalman filter and based on the principle of maximum posterior. It uses the data of the measured variables to dynamically estimate the statistical characteristics of the noise in real time, so as to realize the self-adaptation of the estimation algorithm noise. The Husa algorithm process is as follows.

The time update is shown in the formula. Before proceeding to the next measurement update, add the calculation formula for the measurement noise:

eₖ₊₁=zₖ₊₁−H\hat{x}_{k+1/k}

\hat{R}ₖ₊₁=(1−dₖ)\hat{R}ₖ+dₖ(eₖ₊₁eₖ₊₁^{T}−HP_{k+1/k}H^{T} (102)

Among them, dₖ is the weight of recent data, usually defined as follows

$${d}_{k} = \frac{1 - b}{1 - {b}^{k + 1}} \qquad ( 103 )$$

Among them, b is the forgetting factor, which indicates the degree of forgetting of historical data, which can limit the memory length of the filter and enhance the effect of the newly observed data on the current estimation. The general value is 0.95-0.99.

After the measurement noise is calculated, the Kalman filter measurement update is performed according to the noise value into the formula, and then the system noise at the next moment is calculated:

\hat{Q}ₖ₊₁=(1−dₖ)\hat{Q}ₖ+dₖ(Kₖ₊₁eₖ₊₁eₖ₊₁^{T}Kₖ₊₁^{T}+Pₖ₊₁−F_{k+1/k}PₖF_{k+1/k}^{T} (104)

When k gradually increases, dₖ will tend to 1-b, that is, due to b∈[0.95, 0.99],

$${lim}_{k \to ∞} {d}_{k} ∈ [ 0.01 , 0.05 ] ,$$

when the filtering starts, the dₖ value decreases rapidly, which means that the weight of the observation value at the current moment on the noise estimate is weakened, and the noise information is estimated Most of it still depends on historical information. Therefore, when there is a sudden change in the system, the estimated value of the noise by the Sage-Husa algorithm will not reflect the real situation of the system, and it will easily lead to filter divergence.

In order to solve the possible filtering divergence of the Sage-Husa algorithm in the case of sudden slope changes, the Strong Tracking Filtering Theory (STF) is introduced to improve the tracking and estimation ability of the sudden change system.

A time-varying fading factor is introduced to modify the state prediction error covariance matrix and the corresponding Kalman gain matrix in the Kalman filter recursive process, thereby forcing the residual sequence to be orthogonal or approximately orthogonal. When there is uncertainty or sudden change in the model or measurement value, the STF algorithm calculates the fading factor in order to ensure the irrelevance of the innovation sequence, thereby reducing the influence of historical data on the current filter calculation value, so that the algorithm has the ability to track the sudden change state.

For the Kalman filter recursive system, the steps of state estimation are as follows:

\hat{x}ₖ=\hat{x}_{k/k-1}+Kₖ(yₖ−ŷₖ)

=\hat{x}ₖ+Kₖyₖ (105)

Among them, A is the residual sequence obtained by the state estimation filter equation. The strong tracking filter adds an equation under the condition that the Kalman filter theory satisfies the equation, so that the residual sequence at different times is orthogonal at all times:

E[(xₖ−\hat{x}_{k/k-1})(xₖ−\hat{x}_{k/k-1})^{T}]=min (106)

E[yₖ^{T}yₖ₊ⱼ]=0,k=1,2, . . . ;j=1,2, (107)

In order to make the formula hold, the STF algorithm introduces a time-varying fading factor to adjust the prediction error covariance matrix in real time to further update the Kalman gain. The calculation method of the fading factor is as follows:

$${λ}_{k} = \{ \begin{matrix}{c}_{k} & {c}_{k} > 1 \\ 1 & {c}_{k} \leq 1\end{matrix} \qquad ( 108 )$$

$${c}_{k} = \frac{t r ( {N}_{k + 1} )}{t r ( {M}_{k + 1} )} \qquad ( 109 )$$

$${N}_{k + 1} = {V}_{k + 1} - {H}_{k} {Q}_{k} {H}_{k}^{T} - β {R}_{k - 1} \qquad ( 110 )$$

$${M}_{k + 1} = {H}_{k} {F}_{k} {P}_{k} {F}_{k}^{T} {H}_{k}^{T} \qquad ( 111 )$$

Among them, Vₖ is the residual covariance matrix, defined as follows:

$${V}_{k} = E [ {γ}_{k}^{T} {γ}_{k + j} ] = \{ \begin{matrix}{γ}_{1} {γ}_{1}^{T} & k = 0 \\ \frac{ρ {V}_{k} + {γ}_{k} {γ}_{k + 1}^{T}}{1 + ρ} & k \geq 1\end{matrix} \qquad ( 112 )$$

Among them, 0<ρ≤1 is the forgetting factor, which is generally taken as 0.95, and β≥1 is the weakening factor, increasing the value of β can make the estimation result smoother. F and H are the Jacobian matrices of the system state equation and the observation equation, respectively.

Compared with the original Kalman filter, the strong tracking filter has a very strong ability to track abrupt states. It can maintain the ability to track the state when the system undergoes a sudden change from the equilibrium state.

In summary, the Sage-Husa algorithm can estimate the statistical characteristics of noise without prior information, but it is easy to destroy the positive definiteness of the noise variance matrix and cause filtering divergence. STF can enhance the stability of the filtering system. However, due to the direct correction of the Kalman gain in the filtering process, the optimal estimation result has certain fluctuations. Therefore, the characteristics of the two can be combined. On the one hand, the Sage-Husa algorithm is used to estimate the noise in the filtering process, on the other hand, the STF algorithm is used to correct the covariance in real time in the recursive process.

Step 4: Iterative joint estimation algorithm is used to calculate vehicle mass and road gradient. Since both the Sage-Husa algorithm and STF are based on innovation calculations and affect the covariance in the iterative process, the two algorithms cannot be applied at the same time. For the estimation system, the Sage-Husa algorithm has higher requirements on the stability of the system. When the system noise is known, it can estimate the statistical characteristics of the measurement noise with good accuracy. When a sudden change occurs in the system state, the Sage-Husa algorithm will consider that the increase in measurement noise causes an increase in innovation, and the proportion of measurement information that is originally increased will decrease instead. At this time, if the STF algorithm is used for correction, the optimal estimation result of the STF algorithm will be based on the observation value, that is, it is believed that the accuracy of the observation result is much greater than the state prediction value.

Step five: simulation test. In order to verify the effectiveness of the joint estimation algorithm, an algorithm model is built on the MATLAB/Simulink platform, and the algorithm simulation verification is carried out in conjunction with the CarSim vehicle model. Estimation accuracy analysis: For this joint estimation method, the factors that affect the accuracy of the results include rolling resistance modeling accuracy, air resistance modeling accuracy, and mechanical transmission efficiency value accuracy. Derive the real values of resistance and efficiency from CarSim as input, fix two of them, change one of them, and compare the difference between the simulation result and the real value. Estimation accuracy analysis: For this joint estimation method, the factors that affect the accuracy of the results include rolling resistance modeling accuracy, air resistance modeling accuracy, and mechanical transmission efficiency value accuracy.

Derive the real values of resistance and efficiency from CarSim as input, fix two of them, change one of them, and compare the difference between the simulation result and the real value, as shown in the following table.

TABLE 2
Influence of air resistance

| | | | | | |
|---|---|---|---|---|---|
| Air resistance | −50% | −20% | 0 | 20% | 50% |
| deviation | | | | | |
| Mass | 1.93% | 1.1% | 0.69% | 0.89% | 1.2% |
| estimation | | | | | |
| error | | | | | |
| Slope | 11.1% | 7.41% | 4.63% | 5.7% | 10.23% |
| estimation | | | | | |
| error | | | | | |

TABLE 3
Rolling resistance influence

| | | | | | |
|---|---|---|---|---|---|
| Rolling | −50% | −20% | 0 | 20% | 50% |
| resistance | | | | | |
| deviation | | | | | |
| Mass | 2.6% | 1.27% | 0.8% | 1.1% | 1.54% |
| estimation | | | | | |
| error | | | | | |
| Slope | 9.54% | 6.3% | 3.7% | 5.82% | 8.46% |
| estimation | | | | | |
| error | | | | | |

TABLE 4
Influence of transmission efficiency

| | | | | | |
|---|---|---|---|---|---|
| Transmission | −10% | −5% | 0 | 5% | 10% |
| efficiency | | | | | |
| deviation | | | | | |
| Mass | 10.47% | 5.91% | 1.52% | 3.73% | 8.56% |
| estimation | | | | | |
| error | | | | | |
| Slope | 6.77% | 7.2% | 5.5% | 6.35% | 6.84% |
| estimation | | | | | |
| error | | | | | |

It can be seen from Table 2 and Table 3 that the accuracy of the rolling resistance and air resistance modeling has little effect on the mass estimation results. When the resistance error reaches 50%, the mass estimation error does not exceed 3%, and the slope estimation part is not over 15%, the algorithm is more robust in this respect. However, it can be seen from Table 4 that the value of the transmission efficiency has a great influence on the result of the mass estimation, and the transmission efficiency is used to calculate the driving force of the vehicle, so the accuracy of the value of the driving force of the vehicle has a greater influence on the estimation result. Therefore, for the quality estimation problem of heavy commercial vehicles, the variation of the rolling resistance of different road surfaces and the deviation of the air resistance model account for a relatively small proportion of the traction force, so it has little effect on the quality of the quality estimation. The influence of the driving force of the vehicle as the main power is more obvious. Therefore, the relevant models and parameters of the driving force calculation should be as accurate as possible and targeted modeling and calibration should be carried out for specific products.

Step 6: Real vehicle test; select a vehicle for real vehicle experiment, collect data under different conditions, and analyze the experimental data.

As a preferred embodiment of the present invention, in the longitudinal dynamics model of the first step, the values of the constants are as follows: ηₜ=0.95, C_{D}=0.3, ρ/N·s²·m⁻⁴=1.2258, f=0.0041+0.0000256v, δ=1.1.

As a preferred embodiment of the present invention, the vehicle speed and the nominal engine torque value in the step 1 can be obtained from the vehicle-mounted CAN bus information.

As a preferred embodiment of the present invention, in the fourth step, in the slope estimation algorithm, when the vehicle is running smoothly, the Sage-Husa algorithm is used to perform adaptive noise estimation, so as to reduce the state estimation error of the system and improve the observation accuracy of the filter. When the vehicle driving state changes suddenly, the STF algorithm is used to improve the tracking estimation ability of the Kalman filter and enhance the robustness of the estimation algorithm. Therefore, the Sage-Husa algorithm can be used in combination with the STF algorithm. In a filter cycle, combined with the Kusovkov HT filter convergence criterion, when the filter converges, the Sage-Husa algorithm is used to estimate the slope, when the filter diverges; the STF algorithm is used to estimate the slope.

As a preferred embodiment of the present invention, the iterative joint estimation method of vehicle mass and road slope based on MMRLS and SH-STF analyzes the slowly varying characteristics of vehicle mass and the time-varying characteristics of road gradient. According to the slowly changing and time-varying characteristics, based on the vehicle longitudinal dynamics model and the steering monorail model, the system identification algorithm of recursive least squares is used to calculate the vehicle mass, and the Kalman filter state estimate is used to calculate the road slope by the calculation method, so that the algorithm is better adapted to the estimated variables. A new iterative joint estimation algorithm based on MMRLS and SH-STF is proposed. Multi-model fusion is used to deal with vehicle quality estimation under steering and straight driving conditions. Aiming at the problem of filter divergence caused by sudden gradient changes, a strong tracking filtering algorithm based on noise adaptation is proposed. Adaptive noise estimation is used when the driving is stable, and strong tracking filtering is used when the driving state changes suddenly, which improves the accuracy and stability of the slope estimation.

As a preferred embodiment of the present invention, the iterative joint estimation method of vehicle quality and road gradient based on MNIRLS and SH-STF combines with CarSim software, the joint estimation method is simulated and verified on the Simulink platform with variable quality gradients under multiple working conditions. The influence of rolling resistance, air resistance and transmission efficiency accuracy on the estimation results is analyzed. The results show that under different road conditions, the joint model can accurately estimate the vehicle mass and track changes in road slope in real time. Rolling resistance and air resistance have little effect on the estimation results, while the value of transmission efficiency has a greater impact on the estimation results. Collect real-vehicle driving data under comprehensive road sections, and verify the algorithm in real-vehicle experiments. The results show that the joint estimation method can accurately estimate the vehicle mass and slope in real time, and the joint estimation method is based on the recursive least squares and the second-order matrix extended Kalman filter algorithm for improved design, simple structure, small amount of calculation, and it has high real-car application value.

The above shows and describes the basic principles and main features of the present invention and the advantages of the present invention. For technicians in the field, it is obvious that the present invention is not limited to the details of the above exemplary embodiments, and does not deviate from the spirit or basics of the present invention. In the case of features, the present invention can be implemented in other specific forms. Therefore, from any point of view, the embodiments should be regarded as exemplary and non-limiting. The scope of the present invention is defined by the appended claims rather than the above description, and therefore it is intended to fall into the claims. All changes within the meaning and scope of the equivalent elements of are included in the present invention. Any reference signs in the claims should not be regarded as limiting the claims involved.

In addition, it is understood that although this specification is described in accordance with the embodiments, not every embodiment only includes an independent technical solution. This narration in the specification is only for the sake of clarity. Technicians in the field will regard the specification as a whole. The technical solutions in the embodiments can also be appropriately combined to form other implementations that can be understood by technicians in the field.

1. The iterative joint estimation method of vehicle mass and road gradient based on MMRLS and SH-STF is characterized by including the following steps:
Step 1: Model establishment. First, in order to describe the relationship between mass and slope when the vehicle is traveling in a straight line, a vehicle longitudinal dynamics model is established. In addition, taking into account the common multi-curving road conditions of heavy vehicles, a steering dynamics monorail model is established to analyze the dynamic characteristics of the vehicle when turning, so as to derive the relationship between the vehicle steering state quantity and the quality to improve the accuracy of quality estimation, the details are as follows:
1: Longitudinal dynamics model. Carry on the force analysis to the vehicle, and establish the longitudinal dynamics model of the vehicle according to Newton's second law.
Fₜ=F_{w}+F_{f}+Fᵢ+Fⱼ (113)
In the formula: Fₜ—driving force, F_{w}—air resistance, F_{f}—rolling resistance, Fᵢ—ramp resistance, Fⱼ—acceleration resistance;
Among them,
$${F}_{f} = mgf cos α {F}_{t} = \frac{{T}_{tq} {i}_{g} {i}_{0} {η}_{t}}{r} {F}_{w} = \frac{1}{2} {C}_{D} A ρ {v}^{2} {F}_{i} = mg sin α {F}_{j} = δ ma$$
In the formula: T_{tq}—engine torque, i_{g}—transmission ratio, i₀—main reducer transmission ratio, ηₜ—mechanical efficiency of the drive train, r—wheel diameter, C_{D}—air resistance coefficient, A—windward area, ρ—air Density, v—vehicle speed, f—rolling resistance coefficient, δ—acceleration resistance coefficient;
Considering that the road gradient is generally small, cos α≈1, sin α≈tan α=i can be assumed;
2: Steering dynamic monorail model. Considering that many road conditions require frequent steering operations of the vehicle, according to the tire friction circle theory, the generation of steering torque will affect the longitudinal driving force of the vehicle. Therefore, the steering single-track model is introduced to describe the influence of steering on the longitudinal driving force, and the accuracy of the model is improved, thereby improving the estimation accuracy. The forces F_{xV} and F_{xH} in the wheel direction are front and rear tangential forces, and heavy vehicles are generally front-wheel drive. Therefore, it can be considered that Fₜ=F_{xV}=, F_{xH}=0 the forces F_{yV} and F_{yH} perpendicular to the wheel are lateral forces, and there are lateral air force F_{Ly} and air resistance F_{Lx} at the center of the wind pressure, so the force balance on the longitudinal axis of the vehicle is
$$m \frac{{v}^{2}}{ρ} sin β - m \dot{v} cos β + {F}_{x H} - {F}_{L x} - {F}_{f} + {F}_{x V} cos {δ}_{V} - {F}_{y V} sin {δ}_{V} = 0 \qquad ( 114 )$$
Assuming that the gradient of the vehicle turning is zero, simplify it to:
$$m = \frac{{F}_{t} cos {δ}_{V} - {F}_{y V} sin {δ}_{V} - {F}_{W}}{a cos β + gf - \frac{{v}^{2}}{ρ} sin β} \qquad ( 115 )$$
The reciprocal of the curvature radius ρ of the centroid trajectory in the centripetal acceleration
$$\frac{{v}^{2}}{ρ} ,$$
the curvature 1/ρ is the change of the heading angle (β+ψ) with the arc length u:
$$\frac{1}{ρ} = \frac{d ( β + ψ )}{du} \qquad ( 116 )$$
And because of the speed:
$$v = \frac{d u}{d t} \qquad ( 117 )$$
Therefore, the centripetal acceleration:
$$\frac{{v}^{2}}{ρ} = {v}^{2} \frac{( \dot{β} + \dot{ψ} )}{v} = v ( \dot{β} + \dot{ψ} ) \qquad ( 118 )$$
Assuming that the tire side slip is linear, substitute the front axle lateral force into:
F_{yV=}c_{α}_{_{V}}α_{V} (119)
In the formula, αᵥ is the front axle wheel slip angle, and c_{α}_{_{V}} is the corresponding cornering stiffness;
The components of the front and rear axle speed vectors on the longitudinal axis of the vehicle must be equal, namely, the following formula is obtained:
v cos β=vᵥ cos(δᵥ−αᵥ) (120)
On the vertical axis, the following formula is obtained:
vᵥ sin(δᵥ−αᵥ)=lᵥ\dot{ψ}*+v sin β (121)
From formula (8) and formula (9), the following formula is obtained:
$$tan ( {δ}_{v} - {α}_{v} ) = \frac{{l}_{v} \dot{ψ} + v sin β}{v cos β} \qquad ( 122 )$$
When the steering angle of the wheels is small, the following formula is obtained:
$${α}_{v} = - β + {δ}_{v} - {l}_{v} \frac{\dot{ψ}}{v} \qquad ( 123 )$$
When a heavy-duty vehicle is traveling at a normal high speed, the vehicle's center of mass slip angle changes very little. Therefore, \dot{β}=0, substituting formula (6), formula (7) and formula (11) into formula (3), the following formula is obtained:
$$m = \frac{{F}_{t} cos {δ}_{V} - {c}_{{α}_{v}} ( - β + {δ}_{v} - {l}_{v} \frac{\dot{ψ}}{v} ) sin {δ}_{V} - {F}_{W}}{a cos β + gf - v \dot{ψ} sin β} \qquad ( 124 )$$
Among them,
$${δ}_{v} = \frac{l}{ρ} + m \frac{{c}_{{α}_{H}} {l}_{H} - {c}_{{α}_{V}} {l}_{V}}{{c}_{{α}_{V}} {c}_{{α}_{H}} l} \frac{{v}^{2}}{ρ} \qquad ( 125 )$$
$$β = \frac{{l}_{H}}{ρ} - m \frac{{l}_{v}}{{c}_{{α}_{H}} l} \frac{{v}^{2}}{ρ} \qquad ( 126 )$$
From formula (13) and formula (14), the following formula is obtained:
$${δ}_{v} - β = \frac{{l}_{v}}{ρ} + m \frac{{l}_{H}}{{c}_{{α}_{V}} l} \frac{{v}^{2}}{ρ} > 0 \qquad ( 127 )$$
Because of \dot{β}=0, the following formula is obtained:
$$\dot{ψ} = \frac{v}{ρ} \qquad ( 128 )$$
From formula (15) and formula (16), the following formula is obtained:
$$- β + {δ}_{v} - {l}_{v} \frac{\dot{ψ}}{v} = m \frac{{l}_{H}}{{c}_{{α}_{V}} l} \frac{{v}^{2}}{ρ} > 0 \qquad ( 129 )$$
At this time, formula (12) can be simplified to:
$$m = \frac{{F}_{t} cos {δ}_{V} - {F}_{W}}{a cos β + gf - v ω ( sin β - \frac{{l}_{H}}{l} sin {δ}_{V} )} \qquad ( 130 )$$
Contrast with formula (19):
$$m = \frac{{F}_{t} - {F}_{W}}{a + gf} \qquad ( 131 )$$
It can be known that when the vehicle has a certain steering angle, the estimated value of the mass will be too large. When the steering angle is small, its influence can be ignored. The derivation of the steering model provides a theoretical basis for the mass estimation algorithm under vehicle turning conditions.
Step 2: Iterative joint estimation algorithm architecture; details are as follows:
1: Quality identification algorithm based on MNIRLS. Recursive least squares parameter identification means that when the identified system is running, after each new observation data is obtained, the newly introduced observation data is used to estimate the result of the previous time on the basis of the previous estimation result. According to the recursive algorithm, the new parameter estimates are obtained recursively. In this way, with the successive introduction of new observation data, the parameter calculations are performed one after another until the parameter estimates reach a satisfactory degree of accuracy.
Quality is a slowly changing system parameter. It is more reasonable to use the least square method to estimate it as a system parameter than to use the state estimation algorithm to estimate it, and it has higher calculation efficiency and estimation accuracy. Therefore, the recursive least square method is used to identify the quality.
When the vehicle is driving straight, convert equation (1) into the least square format:
Fₜ−F_{w}=m(gf+gi+δa)+e (132)
Among them, Fₜ−F_{w} is the system input amount, which is recorded as F_{tw}, gf+gi+δa is the observable data amount, which is recorded as a_e, m is the system parameter to be identified, e is the system noise. Substituting it into the formula of the least square method, the least square recursive format of quality identification is as follows:
$$\hat{m} ( k + 1 ) = \hat{m} ( k ) + γ ( k + 1 ) [ {F}_{tw} ( k + 1 ) - {a}_{-} e ( k + 1 ) \hat{m} ( k ) ] \qquad ( 133 )$$
$$γ ( k + 1 ) = P ( k ) {a}_{-} {e ( k + 1 ) [ {a}_{-} e ( k + 1 ) P ( k ) {a}_{-} e ( k + 1 ) + μ ( k + 1 ) ]}^{- 1}$$
$$P ( k + 1 ) = \frac{1}{μ ( k + 1 )} [ I - γ ( k + 1 ) {a}_{-} e ( k + 1 ) ] P ( k )$$
Among them, A is the forgetting factor at the k-th moment, which is selected here according to the following rule:
μ(t)=1−0.05·0.98^{t}
Similarly, when the vehicle is turning, the least square format of the quality identification algorithm is:
$${F}_{t} cos {δ}_{V} - {F}_{W} = m ( a cos β + gf - v ω ( sin β - \frac{{l}_{H}}{l} sin {δ}_{V} ) ) + e \qquad ( 134 )$$
Its recursive format is the same as formula (21);
In the actual driving process of the vehicle, it is difficult to obtain the side slip angle of the center of mass. Therefore, the side slip angle of the center of mass when turning is approximately:
$$β = arctan ( \frac{{l}_{H}}{l} tan {δ}_{v} ) \qquad ( 135 )$$
Due to the dimensionality reduction of the turning model, the accuracy of the quality identification is correspondingly reduced, but it can still play a good role in correcting. In the actual application process, in order to simplify the calculation, it is assumed that the center of gravity of the vehicle is half of the longitudinal direction of the vehicle. Therefore, the identification result will be smaller than actual. In order to improve the accuracy of quality identification, the weight values of the two models are calculated according to the residual probability distributions of the straight-driving and steering models, so as to fuse the identification results of the straight-driving and steering models.
Assuming that the estimated values of the straight driving and steering models at time k are ms(k) and mt(k), respectively, the residual value calculated by the recursive least squares at time k is
eₛ(k)=F_{tw}(k)−mₛ(k)·aₛ(k) (136)
eₜ(k)=Fₜₜ(k)−mₜ(k)·aₜ(k) (137)
Due to the positive and negative signs of the residual value, in order to more accurately quantify the influence of the RLS algorithm error, the residual calculation value is normalized by using the sigmoid function:
$${γ}_{s} ( k ) = \frac{1}{1 + {e}^{- {e}_{s} ( k )}} \qquad ( 138 )$$
$${γ}_{t} ( k ) = \frac{1}{1 + {e}^{- {e}_{t} ( k )}} \qquad ( 139 )$$
The mean square error of the output residual is:
Sₛ(k)=(I−Kₛ(k))Pₛ(k)(I−Kₛ(k))^{T} (140)
Sₜ(k)=(I−Kₜ(k))Pₜ(k)(I−Kₜ(k))^{T} (141)
Then the maximum likelihood functions corresponding to the straight driving and turning models at time k are:
$${Λ}_{s} ( k ) = \frac{1}{\sqrt{2 π \vert {S}_{s} ( k ) \vert}} {e}^{- \frac{1}{2} {γ}_{s} ( k ) {{S}_{s} ( k )}^{- 1} {{γ}_{s} ( k )}^{T}} \qquad ( 142 )$$
$${Λ}_{t} ( k ) = \frac{1}{\sqrt{2 π \vert {S}_{t} ( k ) \vert}} {e}^{- \frac{1}{2} {γ}_{t} ( k ) {{S}_{t} ( k )}^{- 1} {{γ}_{t} ( k )}^{T}} \qquad ( 143 )$$
The available output probability of each model is:
$${u}_{s} ( k ) = \frac{{Λ}_{s} ( k )}{\sum Λ ( k )} \qquad ( 144 )$$
$${u}_{t} ( k ) = \frac{{Λ}_{t} ( k )}{\sum Λ ( k )} \qquad ( 145 )$$
After obtaining the output of each model and its output probability, the fusion result can be obtained
\hat{m}(k)=mₛ(k)·uₛ(k)+mₜ(k)·uₜ(k) (146)
2: The slope estimation algorithm based on EKF. Slope is a state parameter of the system. Compared with state estimation algorithms such as Kalman filter and various observers, the tracking ability of least square method is weak, and it is not suitable for estimating the time-varying state variable such as slope. Therefore, the extended Kalman filter is used to estimate the slope.
When the mathematical model of the system and measurement, the statistical characteristics of the measurement noise and the initial value of the system state are known, Kalman filter uses the measurement data of the input signal and the system model equation to obtain the optimal estimation value of the system state variables and the input signal in real time. Classical Kalman filtering treats the signal process as the output of a linear system under the action of white noise, and describes this input-output relationship with a state equation, and its algorithm uses a recursive form. Its mathematical structure is simple, the amount of calculation is small, and it is suitable for real-time calculation. However, the classical Kalman filter is only applicable to the state estimation of linear systems. For nonlinear systems, there is Extended Kalman Filter (EKF). EKF simplifies the nonlinear model to a linear model by performing Taylor expansion of the nonlinear function near the best estimation point, discarding high-order components, and then using the classic Kalman technique to complete the estimation. EKF is widely used in the state estimation of nonlinear systems.
Write formula (1) as follows:
Fⱼ=Fₜ−F_{w}−F_{f}−Fᵢ (147)
Substituting various formulas, formula (35) becomes as follows:
$$\dot{v} = \frac{1}{δ} ( \frac{{T}_{tq} {i}_{g} {i}_{0} {η}_{t}}{mr} - \frac{1}{2 m} {C}_{D} A ρ {v}^{2} - gf - gi ) \qquad ( 148 )$$
Establish the state space model of the system. The vehicle speed v and the road gradient i are selected as state variables. Since the road gradient i changes slowly, it can be considered that its derivative with respect to time is zero. Therefore, there are the following differential equations:
$$\{ \begin{matrix}\dot{v} ( t ) = \frac{1}{δ} ( \frac{{T}_{tq} ( t ) {i}_{g} {i}_{0} {η}_{t}}{m ( t ) r} - \frac{1}{2 m ( t )} {C}_{D} A ρ {v ( t )}^{2} - gf - gi ( t ) ) \\ \dot{i} ( t ) = 0\end{matrix} \qquad ( 149 )$$
Forward Euler method is used to discretize the state space equation to obtain the discretized difference equation
$$\{ \begin{matrix}{v}_{k + 1} = {v}_{k} + \frac{Δ t}{δ} ( \frac{{T}_{tq} ( {t}_{k} ) {i}_{g} {i}_{0} {η}_{T}}{{m}_{k} r} - \frac{1}{2 {m}_{k}} {C}_{D} A ρ {v}_{k}^{2} - gf - {gi}_{k} ) \\ {i}_{k + 1} = {i}_{k}\end{matrix} \qquad ( 150 )$$
Assuming that the system noise vector and the measurement noise vector are Wₖ and Vₖ respectively, they are independent Gaussian white noise with a mean value of zero. The system noise covariance matrix is Qₖ, and the measurement noise covariance matrix is Rₖ, then the system state equation can be deduced as:
$$[ \begin{matrix}{v}_{k + 1} \\ {i}_{k + 1}\end{matrix} ] = [ \begin{matrix}{v}_{k} + Δ t ( \dot{v} ( {t}_{k} ) ) \\ {i}_{k}\end{matrix} ] + {W}_{k} \qquad ( 151 )$$
Among them,
$$\dot{v} ( {t}_{k} ) = \frac{1}{δ} ( \frac{{T}_{tq} ( {t}_{k} ) {i}_{g} {i}_{0} {η}_{T}}{{m}_{k} r} - \frac{1}{2 {m}_{k}} {C}_{D} A ρ {v}_{k}^{2} - gf - {gi}_{k} ) \qquad ( 152 )$$
The system measurement equation is:
$${z}_{k} = [ \begin{matrix}1 & 0\end{matrix} ] [ \begin{matrix}{v}_{k} \\ {i}_{k}\end{matrix} ] + {V}_{k} \qquad ( 153 )$$
Equations (39) and (41) constitute the state space expression of the system, the expression is as follows:
$$\{ \begin{matrix}{x}_{k + 1} = f ( {x}_{k} ) + {W}_{k} \\ {z}_{k} = {Hx}_{k} + {V}_{k}\end{matrix} \qquad ( 154 )$$
In the formula, H is the measurement matrix;
From equation (42), the slope is estimated according to the EKF algorithm, and the process equation vector function is expanded to obtain the Jacobian matrix:
$${F}_{k} = [ \begin{matrix}\frac{\partial {f}_{1}}{\partial v} & \frac{\partial {f}_{1}}{\partial i} \\ \frac{\partial {f}_{2}}{\partial v} & \frac{\partial {f}_{2}}{\partial i}\end{matrix} ] = [ \begin{matrix}1 - \frac{{C}_{D} A ρ v}{\partial m} Δ t & - \frac{g Δ t}{δ} \\ 0 & 1\end{matrix} ] \qquad ( 155 )$$
The EKF time update equation is:
\hat{x}_{k+1/k}=f(\hat{x}ₖ)
P_{k+1/k}Fₖ(\hat{x}ₖ)PₖFₖ^{T}(\hat{x}ₖ)+Qₖ (156)
In the formula: \hat{x}ₖ—the optimal estimated value of the state variable at the previous moment, Pₖ—the error at the previous moment, \hat{x}_{k+1/k}—the prior estimated value of the state variable, P_{k+1/k}—the prior error covariance, Fₖ—the Jacobian of the process vector function f matrix.
The measurement update equation is
Kₖ₊₁=P_{k+1/k}H^{T}(HP_{k+1/k}H^{T}+Rₖ₊₁)⁻¹
\hat{x}ₖ₊₁=\hat{x}_{k+1/k}Kₖ₊₁(zₖ₊₁−H\hat{x}_{k+1/k})
Pₖ₊₁(I−Kₖ₊₁H)P_{k+1/k} (157)
In the formula: Kₖ₊₁ Kalman gain, \hat{x}^{k+1} posterior estimated value of state variables, Pₖ₊₁—posterior error covariance, I—identity matrix;
According to the measured noise covariance Rₖ and the prior error covariance P_{k+1/k} the Kalman gain dynamically adjusts the weight of the measured variable zₖ and its estimated H_{k+1/k};
Step 3: Improved slope estimation algorithm based on SH-STF. In the actual operation process, changes in the environment may cause changes in the system model or sudden changes in noise. For systems that are prone to changes in the filtering process, if the traditional Kalman filtering is used, it is easy to cause the deviation of the optimal estimation value to increase, or even to diverge the filtering. In the process of vehicle driving, in order to reduce the deterioration of the estimation result caused by the change of the system environment and accelerate the filtering convergence process, the Sage-Husa adaptive filtering algorithm is used to modify the traditional extended Kalman filtering. The Sage-Husa adaptive filtering algorithm is based on the Kalman filter and based on the principle of maximum posterior. It uses the data of the measured variables to dynamically estimate the statistical characteristics of the noise in real time, so as to realize the self-adaptation of the estimation algorithm noise. The Husa algorithm process is as follows.
The time update is shown in the formula. Before proceeding to the next measurement update, add the calculation formula for the measurement noise:
eₖ₊₁=zₖ₊₁−H\ddot{x}_{k+1/k}
\hat{R}ₖ₊₁=(1−dₖ)\hat{R}ₖ+dₖ(eₖ₊₁eₖ₊₁^{T}−HP_{k+1/k}H^{T}) (158)
Among them, dₖ is the weight of recent data, usually defined as follows
$${d}_{k} = \frac{1 - b}{1 - {b}^{k + 1}} \qquad ( 159 )$$
Among them, b is the forgetting factor, which indicates the degree of forgetting of historical data, which can limit the memory length of the filter and enhance the effect of the newly observed data on the current estimation. The general value is 0.95-0.99.
After the measurement noise is calculated, the Kalman filter measurement update is performed according to the noise value into the formula, and then the system noise at the next moment is calculated:
\hat{Q}ₖ₊₁(1−dₖ)\hat{Q}ₖ+dₖ(Kₖ₊₁eₖ₊₁eₖ₊₁^{T}Kₖ₊₁^{T}+Pₖ₊₁−F_{k+1/k}PₖF_{k+1/k}^{T}) (160)
When k gradually increases, dₖ will tend to 1-b, that is, due to b∈[0.95, 0.99],
$${lim}_{k \to ∞} {d}_{k} ∈ [ 0.01 , 0.05 ] ,$$
when the filtering starts, the dₖ value decreases rapidly, which means that the weight of the observation value at the current moment on the noise estimate is weakened, and the noise information is estimated Most of it still depends on historical information. Therefore, when there is a sudden change in the system, the estimated value of the noise by the Sage-Husa algorithm will not reflect the real situation of the system, and it will easily lead to filter divergence.
In order to solve the possible filtering divergence of the Sage-Husa algorithm in the case of sudden slope changes, the Strong Tracking Filtering Theory (STF) is introduced to improve the tracking and estimation ability of the sudden change system.
A time-varying fading factor is introduced to modify the state prediction error covariance matrix and the corresponding Kalman gain matrix in the Kalman filter recursive process, thereby forcing the residual sequence to be orthogonal or approximately orthogonal. When there is uncertainty or sudden change in the model or measurement value, the STF algorithm calculates the fading factor in order to ensure the irrelevance of the innovation sequence, thereby reducing the influence of historical data on the current filter calculation value, so that the algorithm has the ability to track the sudden change state.
For the Kalman filter recursive system, the steps of state estimation are as follows:
\hat{x}ₖ=\hat{x}_{k/k-1}+Kₖ(yₖ−ŷₖ)
=\hat{x}ₖ−Kₖyₖ (161)
Among them, A is the residual sequence obtained by the state estimation filter equation. The strong tracking filter adds an equation under the condition that the Kalman filter theory satisfies the equation, so that the residual sequence at different times is orthogonal at all times:
E[(xₖ−\hat{x}_{k/k-1})(xₖ−\hat{x}_{k/k-1})^{T}]=min (162)
E[yₖ^{T}yₖ₊ⱼ]=0,k=1,2, . . . ;j=1,2, (163)
In order to make the formula hold, the STF algorithm introduces a time-varying fading factor to adjust the prediction error covariance matrix in real time to further update the Kalman gain. The calculation method of the fading factor is as follows:
$${λ}_{k} = \{ \begin{matrix}{c}_{k} & {c}_{k} > 1 \\ 1 & {c}_{k} \leq 1\end{matrix} \qquad ( 164 )$$
$${c}_{k} = \frac{tr ( {N}_{k + 1} )}{tr ( {M}_{k + 1} )} \qquad ( 165 )$$
$${N}_{k + 1} = {V}_{k + 1} - {H}_{k} {Q}_{k} {H}_{k}^{T} - β {R}_{k - 1} \qquad ( 166 )$$
$${M}_{k + 1} = {H}_{k} {F}_{k} {P}_{k} {F}_{k}^{T} {H}_{k}^{T} \qquad ( 167 )$$
Among them, Vₖ is the residual covariance matrix, defined as follows:
$${V}_{k} = E [ {γ}_{k}^{T} {γ}_{k + j} ] = \{ \begin{matrix}{γ}_{1} {γ}_{1}^{T} & k = 0 \\ \frac{ρ {V}_{k} + {γ}_{k} {γ}_{k + 1}^{T}}{1 + ρ} & k \geq 1\end{matrix} \qquad ( 168 )$$
Among them, 0<ρ≤1 is the forgetting factor, which is generally taken as 0.95, and β≥1 is the weakening factor, increasing the value of 0 can make the estimation result smoother. F and H are the Jacobian matrices of the system state equation and the observation equation, respectively.
Compared with the original Kalman filter, the strong tracking filter has a very strong ability to track abrupt states. It can maintain the ability to track the state when the system undergoes a sudden change from the equilibrium state.
In summary, the Sage-Husa algorithm can estimate the statistical characteristics of noise without prior information, but it is easy to destroy the positive definiteness of the noise variance matrix and cause filtering divergence. STF can enhance the stability of the filtering system. However, due to the direct correction of the Kalman gain in the filtering process, the optimal estimation result has certain fluctuations. Therefore, the characteristics of the two can be combined. On the one hand, the Sage-Husa algorithm is used to estimate the noise in the filtering process, on the other hand, the STF algorithm is used to correct the covariance in real time in the recursive process.
Step 4: Iterative joint estimation algorithm is used to calculate vehicle mass and road gradient. Since both the Sage-Husa algorithm and STF are based on innovation calculations and affect the covariance in the iterative process, the two algorithms cannot be applied at the same time. For the estimation system, the Sage-Husa algorithm has higher requirements on the stability of the system. When the system noise is known, it can estimate the statistical characteristics of the measurement noise with good accuracy. When a sudden change occurs in the system state, the Sage-Husa algorithm will consider that the increase in measurement noise causes an increase in innovation, and the proportion of measurement information that is originally increased will decrease instead. At this time, if the STF algorithm is used for correction, the optimal estimation result of the STF algorithm will be based on the observation value, that is, it is believed that the accuracy of the observation result is much greater than the state prediction value.

2. Iterative joint estimation method of vehicle mass and road gradient based on MMRLS and SH-STF according to claim 1, which is characterized in that: in the longitudinal dynamics model of step 1, each constant takes the following values: ηₜ=0.95, C_{D}=0.3, ρ/N·s²·m⁻⁴=1.2258, f=0.0041+0.0000256v, δ=1.1.

3. Iterative joint estimation method of vehicle mass and road gradient based on MMRLS and SH-STF according to claim 1, which is characterized in that: in the first step, the vehicle speed and nominal engine torque values can be obtained from the vehicle-mounted CAN bus information.

4. Iterative joint estimation method of vehicle mass and road gradient based on MMRLS and SH-STF according to claim 1, which is characterized in that: in the fourth step, in the slope estimation algorithm, when the vehicle is running smoothly, the Sage-Husa algorithm is used to perform adaptive noise estimation, so as to reduce the state estimation error of the system and improve the observation accuracy of the filter. When the vehicle driving state changes suddenly, the STF algorithm is used to improve the tracking estimation ability of the Kalman filter and enhance the robustness of the estimation algorithm. Therefore, the Sage-Husa algorithm can be used in combination with the STF algorithm. In a filter cycle, combined with the Kusovkov HT filter convergence criterion, when the filter converges, the Sage-Husa algorithm is used to estimate the slope, when the filter diverges; the STF algorithm is used to estimate the slope.
